(19) United States
(12) Patent Application Publication
(10) Pub. No.: US 2003/0183807 A1
(43) Pub. Date: Oct. 2, 2003

(54) Long decay luminescent powder and process for preparation thereof

(76) Inventors: Virendra Shankar, New Delhi (IN); Harish Chander, New Delhi (IN); Haranath Divi, New Delhi (IN); Pradeep Kumar Ghosh, New Delhi (IN)

Correspondence Address: Morgan & Finnegan L.L.P., Maria C. H. Lin, 345 Park Avenue, New York, NY, 10154-0053, US

(21) Appl. No.: 10/113,555

(22) Filed: Mar. 28, 2002

(51) Int. Cl. C09K 11/08

(52) U.S. Cl. 252/301.4 R

(57) ABSTRACT

Phosphor powder with the basic composition comprising alkaline earth metal aluminate, an activator such as Eu and a co activator has been disclosed. The said phosphor has been synthesized by use of alkaline earth metal salt along with single phase alumina, an activator and a co-activator. The after glow decay was found to be more than 150 hours. The process uses a reducing agent in the form of carbon or an organic compound of carbon.

### FIELD OF INVENTION

The present invention relates to a long decay luminescent powder. The invention particularly provides a process for the preparation of long decay luminescent powder.

### BACKGROUND OF THE INVENTION

Long decay luminescent powders also known as long decay phosphor have the unique property of light emission in the visible range for a quite long time from few seconds to several hours after having been excited by higher energy radiations for short times of the order of one second or less. Applications of these phosphors are almost limitless. To highlight a few, one may include emergency signs and low level lighting escape systems during general power failures or intentional power cuts, military applications, textile printing and textile fibres, lighting apparatus and switches, exit sign boards, electronic instrument dial pads etc.

Long decay luminescent powder based on zinc sulfide activated with copper are known (see for example Indian Patent Application No. 445/DEL/99). These sulfide phosphors are sufficiently bright but decay time is of the order of a few minutes to few hours only.

For many applications such as sign boards etc. still longer decay times are preferred which are normally met by use of radioisotopes like tritium (H-3) and promethium (Pm-147). Because of safety and environmental considerations, there is a serious demand for a luminescent powder without radioactive elements having a decay time of several hours and preferably more than 10 hours.

To meet this demand, recently rare earth activated alkaline earth aluminate phosphor with initial fast decay followed by long persistence at low light levels have been disclosed by Pallila F C, Levine A K and Tomtus M R, in J. Electrochem. Soc., 115, p 642,1968. Lot of efforts have been made to improve phosphorescence characteristics of this class of luminescent materials by means of incorporation of activators/auxiliary activators and other components and following varied steps in their preparation.

Hao et al have disclosed in U.S. Pat. No. 5,853,614) a complex composition consisting of (Sr:Eu) alummate, (Sr:Eu) oxide: n (Al:B:Dy) oxide where n is in a range of 1 to 8. The invention discloses a decay time of more than 40-60 hours burt is dependent on the choice of the value of ‘n’. Further, they teach that the aluminium oxide has to be taken as a mixture of alpha and gamma phases and preferably the minimum amount of alpha phase should be at least 50%. There is a further disclosure that there should be the presence of boron component which essentially comes from the flux material used for effective solid state reaction among the constituents. The amount of boron to be present is to be controlled by the amount of aluminium molar content in the composition and should be in the range of 0.001 to 0.35 mole percent. The variation of n yields luminescence at different wavelenghts e.g., n−1 gives green emission and n=2 gives blue emission. The dislcosed invnetion uses embedding the mixed materials in a carbon powder in a crucible for the synthesis. The disclosed invnetion may have the inevitable problems of controlling the small amount of boron with respect to total aluminium content in the matrix. Another flaw is the need to control the amount of alpha aluminium oxide in relation to gamma type to tailor the brightness and decay time. Additionally the use of a large amount of carbon is used as a reducing agent and prevention of contact of the firing mixture with air. The mixture is embedded in the carbon powder which is considered as an undesirable parameter. All these hitherto mentioned parameters may not result in a phosphor powder with the desired reproducible characteristics of good brightness and long decay times as claimed.

In yet another disclosure by Hao et al in U.S. Pat. No. 5,885,483 the phosphor powder disclosed is MO: (n-x){aAl₂O₃^{α}+(1-a)Al₂O₃^{γ}})xB₂O₃ R . Here again the disclosure does not deviate far from the previous Hao patent and uses the same mixture of aluminium oxide phases. However, the composition becomes a bit more complex with ‘n’ in the previous invnetion getting repalced by (n-x) and also the alkaline earth metal gets replaced by MO, the oxide. Therefore the new dislosure by Hao et al faces the same difficulties as mentioned in the '614 patent.

U.S. Pat. No. 6,010,644 (Fu et al) discloses another complex system with the composition RO:a(Al₁₋ₓGaₓ)₂O₃:b(Y_{1-y}SC_{y})₂ O₂:cB₂O₃:dFu²⁺:eMⁿ. The diosclosure details the characteristics of a similar composition with Y and Sc replaced by Si and Ge and the final composition being RO:a(Al₁₋ₓGaₓ)₂O₃:b(Si_{1-y}Ge_{y}) O₂:cEu²⁺:dMⁿ. Theses two compositions again have complex attributes and also have to be carefully processed for controlled values of the parameters a, b, c and d. The firng is done in an aluminiuk container which may create undesirable shifts in stoichiometry in the composition thereby leading to unbdesirable decay characteristics. Also the phosphor has been characterised to have the decay times of about 24 hours. The reducng atmosphere used here is that of a mixture of hydrogen and nitrogen. The presence of hydrogen in the reducing gaseous atmosphere thereby demands extra care in the processing due to hazardous nature and thereby adding to the cost of production. Over and above this, the very complex nature of the composition puts a serious limitation on the industrial usage of the phosphor due to the ppossibility of rather low yield as also to higher cost of production.

Yen et al in U.S. Pat. No. 6,267,911 disclose long persistence phosphor with green emission with the composition; Mₖ Al₂O₄:2xEu²⁺2yR³⁺. This invention discloses preparation of alpha and berta phases of teh phosphors and claims that quenching from about 650° C. results in far better phosphor with bright emission and longer decay. The claim is that the decay is for more than 16 hours when excitation is effected by a 13W fluorescent light source. The quenching step is claimed to have been performed in air. This claim is in sharp contrast to the '614 patent which teaches us to avoid contact with air of the hot material. The quenching temperature of 650° C. disclosed in '911 patent is thus in obvious contradiction to '614 patent. Process disclosed above in the prior art disclosures generally involves use of hydrogen gas at high temperature that is highly dangerous with possibility of explosions in presence of oxygen containing compounds. The number of preparative compositions and processes is also large. The long decay luminescent powder disclosed in the prior art therefore may be non-uniform, partially luminescent and agglomerated type which has broad particle size distribution for giving rather non uniform brightness

### OBJECTS OF THE INVENTION

The main object of the present invention is to provide a long decay luminescent powder.

Another object is to provide a process for the preparation of long decay luminescent powder using the composition of the present invention.

Yet another object of the present invention is to provide a long decay luminescent powder which is free flowing and has narrow particle size distribution. Still another object is to provide a long decay luminescent powder having low excitation energy.

Another object is to provide a long decay luminescent powder capable of providing varied emission colours.

### SUMMARY OF THE INVENTION

Accordingly, the present invention provides a long decay luminescent powder composition of the formula xRO. (1-x)A₂ O₃:aEu₂ O₃:bM wherein

R is an alkaline earth metal selected from the group consisting of Sr, Ca, Mg and Ba

Al₂O₃ is in single phase

M is selected from the group consisting of Pr, La, Ce, Dy, Sm and Nd,

0.2≦x≦0.8; 0.001≦a≦0.05; and 0.001≦b≦0.1.

In an embodiment of invention, the alkaline earth metal is a salt of least 99.9% purity.

In another embodiment of the invention, the single phase aluminum oxide is independent of α and γ phase.

In a further embodiment of the invention the ratio of aluminum oxide to alkaline earth metal oxide is in the range of from 20:80 to 80:20 wt %.

In another embodiment of the invention M is a salt of at least 99.9% purity.

The present invention also relates to a process for the preparation of long decay luminescent powder of the formula xRO. (1-x)A₂O₃: aEu₂ O₃:bM wherein R is an alkaline earth metal selected from the group consisting of Sr, Ca, Mg and Ba; Al₂ O₃ is in single phase; M is selected from the group consisting of Pr, La, Ce, Dy, Sm and Nd; 0.2≦x≦0.8, 0.001≦a≦0.05; and 0.001≦b≦0.1

which comprises mixing alkaline earth metal salt, Eu salt as activator, a co-activator, flux material and a reducing agent, the said mixture being mixed thoroughly for homogeneity, grinding the mixture and then followed by firing the ground mixture at a temperature in the range of 900-1500° C. in a flowing inert gas for a period in the range of 10 minutes to 24 hours, cooling the fired mixture in flowing inert gas slowly to a temperature of 500° C., removing rapidly the hot mixed fired mass to about 25° C., grinding the resultant cooled material followed by sieving to obtain long decay luminescent powder of particle size not exceeding 100 μm.

In an embodiment of the invention the alkaline earth metal salt is selected from the group consisting of carbonates and alumintes of magnesium, calcium, strontium, barium and any mixture thereof.

In another embodiment of the invention alkaine earth metal salt is at least 99.9% pure.

In still another embodiment of the present invention the activator is selected from compounds of europium and any mixture thereof, convertible to oxide on heating.

In another embodiment of the invention, the activator is at least 99.9% pure.

In still another embodiment of the invention the co-activator is selected from the group consisting of compounds of lanthanum, cerium, praseodymium, neodymium, promethium, samarium, europium, gadolinium, terbium, dysprosium, holmium, erbium, thulium and ytterbium and any mixture thereof, convertible to oxide on heating.

In still further embodiment of the invention the co-activator is at least 99.9% pure.

In an embodiment of the invention flux is selected from boric acid and boron oxide.

In further embodiment of the invention the reducing agent is selected from carbon powder and organic compound of carbon.

In a still further embodiment of the invention the organic compound of carbon is selected from the group consisting of urea, cellulose, sugar and starch.

In an embodiment of the invention, the firing is done in a firing boat made of ceramic, carbon and refractory materials.

In another embodiment of the invention, inert gas is selected from nitrogen and argon.

In another embodiment of the invention, mixing of the reactants is done in a ball mill.

### DETAILED DESCRIPTION OF THE INVENTION

The luminescent powder of the invention with the composition xRO. (1-x)A₂O₃: aEu₂O₃:bM where R is an alkaline earth metal such as Sr, Ca, Mg, Ba; Al₂O3 is independent of phase (α,γ); M comprises Pr, La, Ce, Dy, Sm, Nd and 0.2≦x≦0.8; 0.001≦a≦0.05; and 0.001≦b≦0.1 has a long persistence of more than 150 hours. It gives out light of wavelength depending on the composition used when subjected to radiations ranging from ultra-violet to visible light. The luminescent powder obtained is well crystalline, free flowing and of narrow particle size distribution between 5 to 70 μm.

The advantages of free flowability and narrow particle size distribution of the powders is in device fabrication when the powder is mixed with binders and highly uniform coatings are required. Sign displays and markings of the desired colours are obtained by choice of composition. The application possibilities of such a powder are limitless. Some of them are Exit sign boards, Emergency signs and low level lighting escape systems, Firemen's equipment, Outdoor path markings, Textile printing and Textile fibres etc. The process related to the present invention involves the selection of a host material, from aluminates, either singly or a mixture of two or more, of magnesium, calcium, strontium and barium of 99.9% purity and of size less than 100 μm depending upon the application and the process of device application. The activators are selected from lanthanide group of rare earth activators, either singly or a mixture of two or more, which can be compounds of lanthanum, cerium, praseodymium, neodymium, promethium, samarium europium, gadolinium, terbium, dysprosium, holmium, erbium, thulium, ytterbium of 99.9% purity in the range of 100-10000 ppm based on the required emission colour of the long decay luminescent powder. In the present invention preferred activator chosen is Eu. The aluminate of strontium is added to Europium salt oxidizable on heating. To this is added, a flux in the form of a born compound and Preferably is chosen as boric acid. The use of flux is to facilitate the complete solid state reaction of the mixtrue to give the luminescent powder. A reducing agent is added in the form of carbon or an organic compound of carbon. The organic compound preferably comprises starchurea, sugar, cellulose. Particularly the reducing agent chosen in the present invention is charcoal and urea.

The above composition is powdered and thoroughly mixed. The miixed powder is filled in a ceramic/carbon/any other refractory material container and put in a ceramic enclosure both of which could be heated up to 1600° C. and which is impervious to gases. The mixture is heated at a temperature in the range of 900-1500° C. in a gaseous atmosphere containing mixture of inert gases like nitrogen and argon. The time duration of the firing is in the range of 10 minutes to 24 hours. The thorough blending of components distributes activators uniformly on the grains of host material. High temperature firing in atmosphere of gases described above at temperature in the range of 900-1500° C. forms the host material, dissolves and diffuses the activators, sinters the grains and recrystalisation takes place. The fired material so obtained is ground and further sieved to desired particle size according to the application for which luminescent powder is required.

Novelty of the present invention is in the long decay of at least 150 hours. This novelty has been realised due to the inventive step of use of carbon reducing agent within the mixture during firing.

The following examples are given by way of illustration of the present invention and should not be construed to limit the scope of the present invention.

### EXAMPLE 1

10 gm of strontium aluminate (SrAl₂O₄) powder of 99.9% purity or better of size less than 100 μm is taken. To this 0.17 gm of europium oxide (Eu₂O₃), 0.362 gm of dysprosium oxide (Dy₂O₃), 1 gm of boric acid and 1 gm of urea all of purity equal or better than 99.9% are added and thoroughly mixed and ground. The above composition is filled in covered graphite container and the container is put in a ceramic enclosure of a heating equipment. The atmosphere in the enclosure is that of nitrogen. The temperature is raised to 1100° C. The temperature is maintained for 12 hours. The material is allowed to cool rapidly in the nitrogen atmosphere to room temperature. The fired material is ground and sieved to get a powder of green light emitting long decay luminescent material.

### EXAMPLE 2

10 gm of strontium carbonate (SrCO₃) powder of 99.9% purity or better of size less than 100 μm is taken. To this 7.26 gm of aluminium oxide (Al₂O₃), 0.2324 gm, of europium oxide (Eu₂O₃), 0.510 gm of dysprosium oxide (Dy₂O₃), 1.5 gm of boric acid and 0.2 gm of carbon powder all of purity 99.9% are added and thoroughly mixed and ground. The above composition is filled in covered graphite container and the container is put in a ceramic enclosure of a heating equipment. The atmosphere in the enclosure is that of a mixture of nitrogen argon in he ratio of 10:1 by volume. The temperature is raised to 1200° C. The temperature is maintained for 8 hours. The material is allowed to cool in the nitrogen atmosphere to room temperature. The fired material is ground and sieved to get a powder of green light emitting long decay luminescent material.

### EXAMPLE 3

10 gm of calcium carbonate (CaCO₃) powder of 99.9% purity or better of size less than 100 μm is taken. To this 8.35 g of aluminium oxide (Al₂O₃), 0.25 g of europium oxide (Eu₂O₃), 1.40 gm of neodymium (Nd₂O₃), 1.5 gm of boron oxide and 1.2 gm of carbohydrazide powder all of purity equal or better than 99.9% are added and thoroughly mixed and ground. The above composition is filled in covered graphite container and the container is put in a ceramic enclosure of a heating equipment. The atmosphere in the enclosure is that of a mixture of nitrogen and argon in he ratio of 10:1 by volume. The temperature is raised to 1400° C. The temperature is maintained for 6 hours. The material is allowed to cool in the nitrogen atmosphere to room temperature. The fired material is ground and sieved to get a powder of blue light emitting long decay luminescent material.

### EXAMPLE 4

10gm of strontium carbonate (SrCO₃) powder of 99.9% purity or better of size less than 100 μm is taken. To this 5.1gm of aluminium oxide (Al₂O₃), 0.6 gm of europium oxide (Eu₂O₃), 0.34 g of dysprosium oxide (Dy₂O₃), 11.0 gm of boron oxide and 2.0 g of carbon powder all of purity equal or better than 99.9% are added and thoroughly mixed and ground. Above composition is filled in covered high purity alumina container and container is put in a ceramic enclosure of a heating equipment. The atmosphere in the enclosure is that of nitrogen. The temperature is raised to 1000° C. The temperature is maintained for 15 hours. Material is allowed to cool in nitrogen atmosphere to room temperature. Fired material is ground and sieved to get a powder of yellow-orange light emitting long decay luminescent material.

Main Advantages of the Invention are:

1 The luminesecent powder is free flowing for application in sign boards.

2 The process is less cumborsome due to limited number of constituents.

We claim:

1. A long decay luminescent powder composition of formula xRO. (1-x)Al₂O₃: aEu₂O₃:bM wherein R is an alkaline earth metal selected from the group consisting of Sr, Ca, Mg and Ba; Al₂ O₃ is in single phase; M is selected from the group consisting of Pr, La, Ce, Dy, SmandNd; and 0.2≦x≦0.8; 0.001≦a≦0.05; and 0.001>b≦0.1.

2. A composition as claimed in claim 1 wherein the alkaline earth metal is a salt of least 99.9% purity.

3. A composition as claimed in claim 1 wherein the single phase aluminum oxide is independent of α and γ phase.

4. A composition as claimed in claim 1 wherein the ratio of aluminum oxide to alkaline earth metal oxide is in the range of from 20:80 to 80:20 wt %.

5. A composition as claimed in claim 1 wherein the M is a salt of at least 99.9% purity.

6. A process for the preparation of long decay luminescent powder of the formula xRO. (1-x)A₂O₃: aEu₂O₃:bM wherein R is an alkaline earth metal selected from the group consisting of Sr, Ca, Mg and Ba; A₂O₃ is in single phase; M is selected from the group consisting of Pr, La, Ce, Dy, Sm and Nd; 0.2≦x≦0.8; 0.001≦a≦0.05; and 0.001≦b≦0.1; which comprises mixing an alkaline earth metal salt, Eu salt as activator, a coactivator, flux material and a reducing agent, provided that alumina is added along with the alkaine earth metal salt when it is not an aluminate, the said mixture being mixed thoroughly for homogeneity, grinding the mixture and then followed by firing the ground mixture at a temperature in the range of 900-1500° C. in a flowing inert gas for a period in the range of 10 minutes to 24 hours, cooling the fired mixture in flowing inert gas slowly to a temperature of 500° C., removing rapidly the hot mixed fired mass to about 25° C., grinding the resultant cooled material followed by sieving to obtain long decay luminescent powder of particle size not exceeding 100 gm.

7. A process as claimed in claim 6 wherein the alkaline metal salt is selected from the group consisting of carbonates or aluminates of magnesium, calcium, strontium, barium and any mixture thereof.

8. A process as claimed in claim 6 wherein the alkaline earth metal is at least 99.9% pure.

9. A process as claimed in claim 6 wherein the activator is selected from compounds of europium and any mixture thereof, convertible to oxide on heating.

10. A process as claimed in claim 6 wherein the activator is at least 99.9% pure.

11. A process as claimed in claim 6 wherein the co-activator is selected from the group consisting of compounds of lanthanum, cerium, praseodymium, neodymium, promethium, samarium, europium, gadolimum, terbium, dysprosium, holmium, erbium, thulium and ytterbium and any muture thereof, convertible to oxide on heating.

12. A process as claimed in claim 6 wherein the co-activator is at least 99.9% pure.

13. A process as claimed in claim 6 wherein the flux is selected from boric acid and boron oxide.

14. A process as claimed in claim 6 wherein the reducing agent is selected from carbon powder and organic compound of carbon.

15. A process as claimed in claim 14 wherein the organic compound of carbon is selected from the group consisting of urea, cellulose, sugar and starch.

16. A process as claimed in claim 6 wherein the firing is done in a firing boat made of ceramic, carbon and refractory materials.

17. A process as claimed in claim 6 wherein the inert gas is selected from nitrogen and argon.

18. A process as claimed in claim 6 wherein the mixing of the reactants is done in a ball mill.
